(19) United States
(12) Patent Application Publication
(10) Pub. No.: US 2003/0112912 A1
(43) Pub. Date: Jun. 19, 2003

(54) Carrier sense apparatus for data communication

(76) Inventors: Jong Won Kim, Daejeon (KR); Ji Eun Kim, Daejeon (KR); Je In Baek, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/319,158

(22) Filed: Dec. 12, 2002

(30) Foreign Application Priority Data
Dec. 13, 2001 (KR) 2001-78868

(51) Int. Cl. H04L 25/38

(52) U.S. Cl. 375/369

(57) ABSTRACT

Disclosed is a carrier sense (CS) apparatus for data communication. The carrier sense apparatus for data communication detects a start time point and an end time point of a reception frame using a power threshold value and a time threshold value of a preset signal to recognize a length of the reception frame at a modem receiver for data communication. The apparatus includes a power converter for converting a voltage value of an input signal into a power value; a power accumulator for accumulating the power value for a prescribed window interval; a power threshold comparator for comparing an accumulated power value generated from the power accumulator with a predetermined power threshold value, and generating the result value; and a time threshold comparator for counting a predetermined time for which the result value generated from the power threshold comparator is continuously maintained, and determining whether the counted time exceeds a predetermined time threshold value. Therefore, the apparatus considers a threshold value in view of two aspects being time and power, and effectively detects accurate start and end time points of a reception frame under a poor channel environment without increasing the load on hardware.

### BACKGROUND OF THE INVENTION

1. Field of the Invention

The present invention relates to a carrier sense apparatus for data communication, and more particularly to a carrier sense apparatus for data communication for detecting a start time point and an end time point of a reception frame using a power threshold value and a time threshold value of a preset signal to recognize a length of the reception frame at a modem receiver for data communication.

2. Description of the Related Art

Typically, a carrier sense circuit for controlling an operating mode and a standby mode of a receiver has been used for a modem for data communication. Also, a homePNA (Home Phoneline Networking Alliance) 2.0 system has adapted such a carrier sense circuit to recognize a length of a received frame at a MAC. However, in the case where a conventional carrier sense circuit is used under a poor channel environment as in a phoneline modem, it is difficult for the conventional carrier sense circuit to maintain a signal from a start time point to an accurate end time point of a received frame. Particularly, in the case where a carrier sense circuit is used for a typical Ethernet or an optical transmission system under a poor channel environment as in the HomePNA system, probability of generating false alarms or miss alarms becomes higher and it is impossible to obtain a desired signal at the carrier sense circuit.

A representative carrier sense circuit is shown in FIG. 1. Referring to FIG. 1, a reception signal x is applied to a square unit 11, and is converted into a power signal y for a one signal sample. The power signal y is accumulated by a prescribed energy for a prescribed window interval at a mean power calculator 12 such that a mean energy is calculated by the mean power calculator 12. The mean energy is compared with an energy threshold value preset by a comparator 13 such that a carrier sense signal is activated or inactivated.

However, the aforementioned conventional carrier sense circuit obtains a desired carrier sense signal under a relatively good channel environment, but has disadvantages in that transmission characteristics are deteriorated by a bridge tap such as a HomePNA 2.0 system, impulse noise is caused by a pre-installed telephone or ADSL (Asymmetric Digital Subscriber Line), crosstalk is generated from a neighbor line, and the power restriction requirements are unavoidable. Therefore, it is difficult for the conventional carrier sense circuit to accurately detect an end time point because data variations become serious under a poor channel environment. Also, the conventional carrier sense circuit recognizes a weaker signal as an interrupted signal under such a poor channel environment, thereby increasing the probability of false alarms. In the case where the threshold value is lowered to reduce the probability of false alarms, the conventional carrier sense circuit detects a noise signal having energy lower than that of a reception signal. As a result, the conventional carrier sense circuit may increase the probability of false alarms, and may detect a wrong signal such as noise.

Further, in the case where a system for estimating a length of a frame using a carrier sense signal detects a start time point and an end time point, it is necessary for the detected start and end time points of the frame to be identical with those of a real frame. However, the conventional carrier sense circuit increases an energy accumulation time to reduce the probability of false alarms, thereby increasing a time error value.

In the meantime, there have been proposed a variety of conventional carrier sense methods. One such conventional carrier sense method is described in Korean Patent Application No. 1991-21145, entitled “CARRIER SENSE METHOD IN USING FACSIMILE CONNECTED TO DIGITAL TELEPHONE”, which is incorporated herein by reference. This carrier sense method checks start and end parts of a carrier sense signal, compares the start part with a previous bit, increases a count value of a toggle bit when the start part and the previous bit are different from each other, determines whether the count value of the toggle bit reaches a given count value, sets a RTS (Ready To Send) mode to a digital telephone when the count value of the toggle bit reaches a given count value, and is then switched to a mode for checking the end part of the carrier sense signal. In the mode for checking the end part of the carrier sense signal, the carrier sense method compares the end part with a previous bit, increases a count value of a toggle bit when the end part and the previous bit are different from each other, determines whether the prescribed number of bits are received, clears the RTS mode of the digital telephone when the prescribed number of bits are received and the count value of the toggle bit is less than a given count value, and is then switched to the mode for checking the start part of the carrier sense signal. Therefore, the aforesaid carrier sense method according to the Korean Patent Application No. 1991-21145 analyzes exchange signals between the digital telephone and the facsimile, and controls a counterpart telephone to display a RTS mode on the basis of the analyzed result, thereby accomplishing effective data communication. However, the above carrier sense method is adapted only to a connection configuration between the digital telephone and the facsimile such that it cannot accurately detect start and end time points of a reception signal during a packet transmission mode serving as a data communication/transmission mode, and increases a time error value.

Meanwhile, there has been proposed another conventional art for describing an energy detector applicable to a noise fluctuating channel, entitled “ENERGY DETECTOR PERFORMANCE IN A NOISE FLUCTUATING CHANNEL” on Military Communications Conference Vol. 1, pp. 85˜89, proposed by Khiem V. Cai Vu Phan, Roger H.O'connor et al. However, this conventional art is provided to maintain the probability of false alarms by increasing a threshold value of a threshold comparator using channel fluctuation in a noise fluctuating channel.

In conclusion, it is necessary for a carrier sense circuit to accurately detect start and end time points of a reception frame under a poor channel environment in data communication in such a way that it reduces the probability of false alarms and a time error value between a reception data frame and a real data frame.

### SUMMARY OF THE INVENTION

Therefore, the present invention has been made in view of the above problems, and it is an object of the present invention to provide a carrier sense apparatus for data communication for considering a threshold value in view of two aspects being time and power, and effectively detecting accurate start and end time points of a reception frame under a poor channel environment without increasing the load on hardware.

In accordance with the present invention, the above and other objects can be accomplished by the provision of A carrier sense apparatus for data communication, including: a power converter for converting a voltage value of an input signal into a power value; a power accumulator for accumulating the power value for a prescribed window interval; a power threshold comparator for comparing an accumulated power value generated from the power accumulator with a predetermined power threshold value, and generating the result value; and a time threshold comparator for counting a predetermined time for which the result value generated from the power threshold comparator is continuously maintained, and determining whether the counted time exceeds a predetermined time threshold value.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a block diagram of a conventional carrier sense apparatus;

FIG. 2 is a view illustrating a block diagram of a carrier sense apparatus in accordance with a preferred embodiment of the present invention;

FIG. 3 is a view illustrating a detailed block diagram of a power threshold comparator shown in FIG. 2 in accordance with a preferred embodiment of the present invention; and

FIG. 4 is a view illustrating a block diagram of a time threshold comparator shown in FIG. 2 in accordance with a preferred embodiment of the present invention.

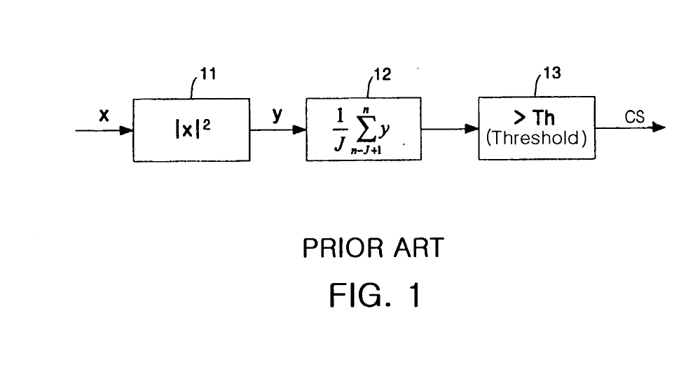

### DESCRIPTION OF THE PREFERRED EMBODIMENTS

Now, preferred embodiments of the present invention will be described in detail with reference to the annexed drawings.

Although the annexed drawings depict a carrier sense apparatus widely used for a data communication system, such a carrier sense apparatus can be applicable to a variety of communication systems.

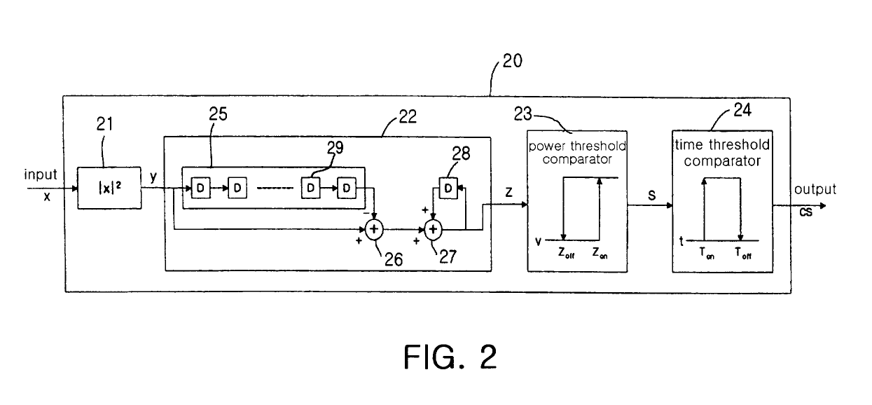

FIG. 2 is a view illustrating a block diagram of a carrier sense apparatus in accordance with a preferred embodiment of the present invention. Referring to FIG. 2, the carrier sense apparatus includes a power converter 21 for receiving an input signal x applied to a device such as a modem, and converting a voltage value of the input signal x into a power value y; a power accumulator for accumulating the power value for a prescribed window interval upon receiving the power value y, and generating the accumulated power value z; a power threshold comparator 23 for comparing the accumulated power value z with each power threshold value at start and end time points; and a time threshold comparator 24 for comparing an output signal of the power threshold comparator 23 with a predetermined time threshold value. Preferably, although the power converter 21 is implemented with a square unit and the power accumulator 22 is implemented with an interval integrator, they can be easily modified in various ways by those skilled in the art. Preferably, the input signal x is adapted as a sample signal with a frame format.

The power y generated from the power converter 21 is accumulated during a prescribed window interval at the power accumulator 22. In this case, the power accumulator 22 uses a sliding window. The sliding window represents a specific window where all positions of a given signal frame are respectively adapted as a start position. Such a window is set up by a system, and the input signal is composed of the set of samples.

Referring to FIG. 2, the power accumulator 22 includes a first delay 25 having at least one delay component 29 for storing power values of sample signals, and delaying signal transmission, a subtracter for subtracting an output power value of the first delay 25 from a power value of an input sample signal of the power accumulator 22, a second delay 27 for delaying an output power value of the subtracter by one sample, and an adder 28 for adding an output power value of the second delay 27 and the output power value of the subtracter 26. In this case, the number of delay components contained in the first delay 25 is less than the number of input signal samples N. For instance, provided that a window is composed of five samples, the number of delay components contained in the first delay 25 is 4 (i.e., 5−1).

The first delay 25 stores a power value for a sample signal corresponding to a window interval, stores the next sample signal as soon as the next sample signal is received, and at the same time outputs the power value of the pre-stored sample signal to the subtracter 26. The second delay 27 continuously accumulates an output value of the subtracter 26, and outputs the accumulated output value to the adder 27 for adding the accumulated output value and a power value of the newly input sample signal. As a result, in case of receiving such a newly input sample signal, a power value for a window interval is continuously accumulated, and the accumulated power value finally becomes an output value of the power accumulator 22. Likewise, a sample signal of the input voltage is accumulated by a prescribed window interval at the power accumulator 22, and a new power value for the prescribed window interval is accumulated even though other sample signals are continuously received. In this way, the power accumulator 22 generates the accumulated power value.

A procedure for detecting a start time point and an end time point of a reception signal to detect a length of a reception signal frame and the accompanied apparatus for the procedure will hereinafter be described in more detail with reference to FIG. 2.

As stated above, a power value is accumulated during a prescribed window interval at the power accumulator 22, and the accumulated power value signal is applied to the power threshold comparator 23.

In accordance with the carrier sense apparatus according to the present invention, a state where input signals are continuously detected using the aforementioned ways is defined as CS activation, and this CS (Carrier Sense) activation is represented as a “CS=1”. On the contrary, another state where input signals are not detected is defined as a CS inactivation, and this CS inactivation is represented as a “CS=0”. Therefore, in case of the CS inactivation state represented as “CS=0”, an operating mode of the carrier sense apparatus is switched to a mode for detecting a start time point of an input signal because it does not detect such input signals. In case of the CS activation represented as “CS=1”, an operating mode of the carrier sense apparatus is switched to a mode for detecting an end time point of the detected signal because it continuously detects the input signals.

Firstly, the operation for detecting the start time point of a frame signal under the state of CS=0 is accomplished by comparing the accumulated voltage value z generated from the power accumulator 22 with a power threshold value Zon preset by the power threshold comparator 23.

In more detail, an operating mode of CS=0 is initially set up under the condition that the power threshold comparator 23 detects no input signal. In the case where the power threshold comparator 23 detects a start time point of the input signal after receiving the input signal, it compares a power threshold value Zon with the accumulated power value z. As a result, if the accumulated power value z is higher than the power threshold value Zon, the power threshold comparator 23 outputs a signal of 1. If the accumulated power value z is less than or the same as the power threshold value Zon, the power threshold comparator 23 outputs a signal of 0. In this case, an output value s of the power threshold comparator 23 is based on a first preferred embodiment of the present invention, but it is not limited thereto and may be set to another value on the basis of the power threshold value set by the power threshold comparator. Such operations and concepts are applied to the following description in the same manner as the aforementioned.

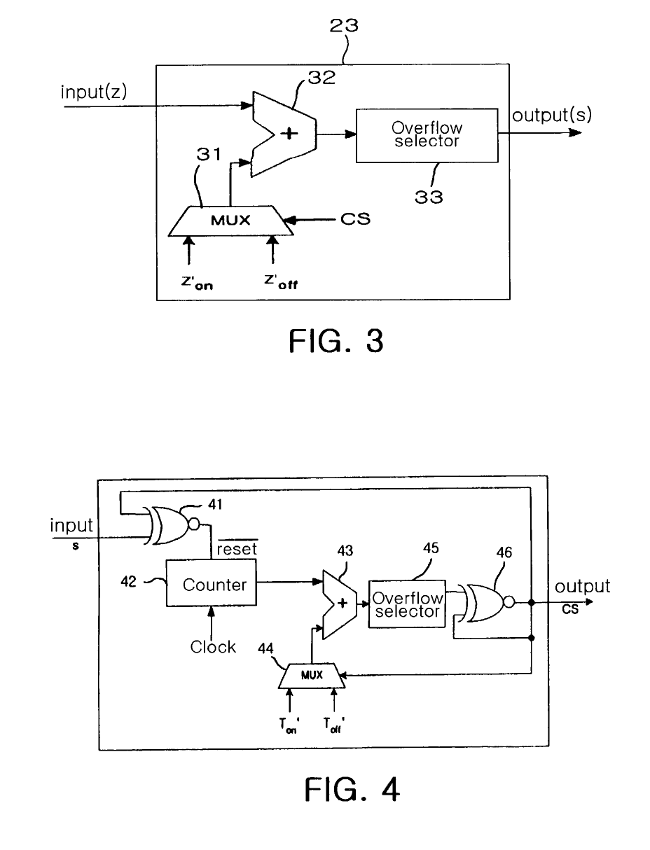

In this case, the power threshold comparator 23 uses an adder instead of a comparator, and its detailed configuration is described in FIG. 3. FIG. 3 is a view illustrating a detailed block diagram of a power threshold comparator 23 shown in FIG. 2 in accordance with a preferred embodiment of the present invention. Referring to FIG. 3, a multiplexer MUX 31 outputs a power value Z'on serving as a 1's complement of the power threshold value Zon in case of CS=0, and outputs another value Z'off in case of CS=1. That is, in the case where a signal of CS=0 for indicating a start time point of a reception signal is applied to the multiplexer MUX 31, the multiplexer MUX 31 generates the value Z'on. On the contrary, in the case where a signal of CS=1 for indicating an end time point of the reception signal is applied to the multiplexer MUX 31, the multiplexer MUX 31 generates the value Z'off. In this case, the value Z'on is the same as a 1's complement of the power threshold value Zon used in case of CS=0, and the other value Z'off is the same as a 1's complement of the other power threshold value Zoff used in case of CS=1. For example, provided that the value Zon is set to a signal ‘1010’ composed of four bits, the value Z'on of the power threshold comparator 23 becomes a signal ‘0101’.

Subsequently, in the case where the power threshold comparator 23 detects the start time point of a reception signal in case of CS=0, it adds the value Z'on and the accumulated power value z generated from the power accumulator 22 at an adder 32. Then, the power threshold comparator 23 uses an overflowed MSB (Most Significant Bit) among the added result values as its own output value s. Here, the power threshold comparator 23 adapts an overflow selector 33 to generate the overflowed MSB. Preferably, the overflow selector 33 selects and generates a signal of 0 when the adder 32's addition result of signals composed of the same number of bits has a prescribed bit number which is the same as the number of previous bits before such addition. The overflow selector 33 selects and generates a signal of 1 when the adder 32's addition result has another prescribed bit number higher than the number of previous bits before such addition. For instance, if the signals of 1010 and 0001 are added each other, a resultant signal of 1011 is provided. In this case, the number of bits composed of the added result value (i.e., 1011) is 4 and this bit number 4 is the same as each previous signal before such addition, therefore the overflow selector 33 selects a signal of 0. In the case where a signal of 10000 is provided by addition of a signal 1010 and a signal 0110, the number of bits of the result value is 5. So, the 5 bits are higher than the previous 4 bits such that the overflow selector 33 selects the signal of 1. As for the power threshold value Zon, its complement Z'on and the accumulated power value z, their bit numbers are predetermined.

In this way, in the case where the power threshold comparator 23 compares the accumulated power value z generated from the power accumulator 22 with the predetermined power threshold value Zon, it uses the complement value Z'on serving as a 1's complement of the power threshold value Zon. Therefore, in the case where the accumulated power value z generated from the power accumulator 22 is higher than or the same as the power threshold value Zon, the power threshold comparator 23 generates an overflowed bit of 1. On the contrary, in the case where the accumulated power value z is less than the power threshold value Zon, the power threshold comparator 23 generates a bit of 0. In this case, as described above, the power threshold comparator 23 uses an adder instead of a comparator to reduce the load on hardware.

Subsequently, an output value of the power threshold comparator 23 is applied to a time threshold comparator 24. The time threshold comparator 23 sets a time threshold value to a value Ton in case of CS=0. The time threshold value Ton is defined as a prescribed number counted whenever the accumulated power value z exceeds the power threshold value Zon, or is defined as a reception signal duration time for which the accumulated power value z exceeding the power threshold value Zon is received at the time threshold comparator 24.

In this case, the time threshold comparator 24 uses an adder instead of a comparator, and its detailed configuration is shown in FIG. 4. FIG. 4 is a view illustrating a detailed block diagram of the time threshold comparator 24 shown in FIG. 2 in accordance with a preferred embodiment of the present invention. Referring to FIG. 4, the time threshold comparator 24 uses 1's complements T'on and T'off of the time threshold values Ton and Toff.

Firstly, a first XOR (exclusive-OR) gate 41 generates a signal of 0 when a signal of CS is identical with the output value s of the power threshold comparator 23, and generates a signal of 1 when they are different from each other. Therefore, in the case where a CS inactivation state of CS=0 is provided and the output value s is ‘0’, a reset mode is provided so that a counter 42 is not operated. However, in the case where the output value s is switched to ‘1’ even though the state of CS=0 is provided, the counter 42 is operated. The counter 42 need not receive additional input signals, but receives just two signals being a reset signal and a clock signal. In the case where the reset signal is applied to the counter 42, the counter 42 generates a signal of 0. In the case where the reset signal is not applied to the counter 42, the counter 42 generates an output signal whose value increases one by one on the basis of the clock signal value. Referring to FIG. 4, a multiplexer MUX 44 outputs a power value T'on serving as a 1's complement of the time threshold value Ton in case of CS=0, and outputs another value Z'off in case of CS=1. That is, in the case where a signal of CS=0 for indicating a start time point of a reception signal is applied to the multiplexer MUX 44, the multiplexer MUX 44 generates the value T'on. On the contrary, in the case where a signal of CS=1 for indicating an end time point of the reception signal is applied to the multiplexer MUX 44, the multiplexer MUX 44 generates the value T'off. In this case, the value T'on is the same as a 1's complement of the time threshold value Ton used in case of CS=0, and the other value T'off is the same as a 1's complement of the other power threshold value Toff used in case of CS=1.

Subsequently, in the case where the time threshold comparator 24 detects the start time point of a reception signal in case of CS=0, it adds the output value T'on and the output value of the counter 42 at an adder 43. Then, the time threshold comparator 24 transmits an overflowed bit among the added result values to a second XOR gate 46, and at the same time transmits the value of CS to the second XOR gate 46. Here, the time threshold comparator 24 adapts an overflow selector 45 to generate the overflowed bit.

The value T'on is applied to the adder 43 in case of CS=0. Then, if the output value of the counter 42 is higher than the value T'on, then the state of CS=0 is switched to the other state of CS=1. But, if the output value of the counter 42 is less than the value T'on even in case of CS=0, then the state of CS=0 is maintained. On the contrary, the value T'off is applied to the adder 43 in case of CS=1. In this case, this condition where the output value of the counter 42 is higher than the value T'off means that samples not exceeding the power threshold value T'off are continuously received at the time threshold comparator 24, therefore the value of CS is ‘0’, i.e., CS=0. But, if the output value of the counter 42 is less than the value T'off even in case of CS=1, then the state of CS=1 is maintained.

The time threshold comparator 24 adapts the output value of the overflow selector 45 and a current CS value as input signals, and outputs the output signal of the second XOR gate 46 as a value of CS. The output signal of the second XOR gate 46 is shown in the following Table 1.

TABLE 1

| Overflow Selector\CS | 0 | 1 |
|---|---|---|
| 0 | 2nd XOR gate 46's | 2nd XOR gate 46's |
| | result value = 0 | result value = 1 |
| 1 | 2nd XOR gate 46's | 2nd XOR gate 46's |
| | result value = 1 | result value = 0 |

In this way, in the case where the time threshold comparator 24 compares the output value s of the power threshold comparator 23 with the predetermined time threshold value Ton, it uses the complement value T'on serving as a 1's complement of the time threshold value Ton. Therefore, in the case where the output value s of the power threshold comparator 23 is higher than or the same as the time threshold value Ton, the time threshold comparator 24 generates a bit of 1. On the contrary, in the case where the output value s of the power threshold comparator 23 is less than the time threshold value Ton, the time threshold comparator 24 generates a bit of 0. In this case, as described above, the time threshold comparator 24 uses an adder instead of a comparator to reduce the load on hardware.

Therefore, if the output value of the power threshold comparator 23 is ‘1’, then the time threshold comparator 24 counts a predetermined time for which the output value of 1 is maintained. If the counted value exceeds the time threshold value Ton, then the output signal CS of the time threshold comparator 24 is activated to establish a state of CS=1. If the counted value does not exceed the time threshold value Ton, an input signal of the time threshold comparator 24 is switched to the other signal to initialize the counter 42.

Also, if the output value of the power threshold comparator 23 is ‘0’, then the time threshold comparator 24 controls a CS output value to be ‘0’ without comparing the output value of 0 with the time threshold value Ton, thereby maintaining an initial CS inactivation state.

A procedure for detecting an end time point of the input signal will hereinafter be described with reference to FIGS. 3 and 4. Under the condition that input signals are continuously sensed, this procedure is adapted to find each end time point of the input signals. So, this procedure starts at a state of CS=1, i.e., a CS activation state.

In case of a CS activation state represented as CS=1, an operating mode of the carrier sense apparatus is switched to an operating mode for detecting an end time point of an input signal. In this case, the power threshold comparator 23 and the time threshold comparator 24 adopt a power threshold value Zoff and a time threshold value Toff, respectively. This case is contrary to the aforementioned state of CS=0. Referring to FIG. 3, the multiplexer 31 generates a power threshold value Z'off upon receiving a signal of CS=1. The power threshold comparator 23 adds the power threshold value Z'off and the accumulated power value z generated from a power accumulator 22 at an adder 32, and then generates an overflowed bit of the added result. In the case where the accumulated power value z is higher than or the same as the power threshold value Zoff, the power threshold comparator 23 generates an output value of 1. On the contrary, in the case where the accumulated power value z is less than the power threshold value Zoff, the power threshold comparator 23 generates an output value of 0. In this case, the output value of 1 generated from the power threshold comparator 23 means that the input signals are successive valid frame signals.

Subsequently, an output signal s of the power threshold comparator 23 is applied to the time threshold comparator 24. Referring to FIG. 4, in the case where a CS activation state of CS=1 is provided and the output value s is ‘1’, a reset mode is provided so that a counter 42 is not operated. However, in the case where the output value s is switched to ‘1’ even though the state of CS=1 is provided, the counter 42 is operated.

Also, the multiplexer 44 generates a time threshold value T'off in case of CS=1, and the time threshold value T'off is applied to an adder 43. In this case, if an output value of the counter 42 is higher than the time threshold value T'off, this means that samples having a power value less than the power threshold value are received. At this time, a signal end time point is determined such that a state of CS=0 is provided. That is, an overflowed MSB is generated from the addition result of the output value of the counter 42 and the time threshold value T'off. The overflowed bit and the CS value are applied to a second XOR gate 46. In this case, the output signal of the second XOR gate 46 is shown in the aforementioned Table 1.

Therefore, the time threshold comparator 24 starts a counting operation when an output signal of the power threshold comparator 23 is ‘0’. In the case where the output signal of 0 is maintained for a threshold time Toff while performing such counting operation, a CS signal is inactivated as a state of CS=0. If the power threshold comparator 23 transmits a signal of 1 to the time threshold comparator 24, a counter 42 contained in the time threshold comparator 24 is initialized. Then, if a signal of 0 is received at the counter 42, the counter 42 again performs a counting operation.

If the CS signal is inactivated as a state of CS=0, an operating mode of the carrier sense apparatus according to the present invention is switched to a mode for detecting a start time point of a reception signal. Therefore, the power threshold comparator 23 and the time threshold comparator 24 adopt a power threshold value Zon and a time threshold value Ton, respectively.

As described above, the carrier sense apparatus according to the present invention uses both the power threshold value and the time threshold value. Therefore, although input signal waves are severely curved by a channel distortion or signal interference, the start and end time points can be relatively less affected by the severely curved signal waves. Also, there is no need to excessively increase an accumulation interval using integral calculation prior to the power threshold comparator 23. As a result, there is little difference between the detected start and end time points and those of a real frame.

Although the carrier sense apparatus is adapted only to use an input signal frame with reference to the annexed drawings and their detailed description, it can be manufactured in various ways for each application field of data communication systems such as a HomePNA 2.0 system. The input signal frame is adapted as only a preferred example to more clearly explain the present invention, but it is understood that various other modifications will be apparent to and can be readily made by those skilled in the art without departing from the scope and spirit of this invention. Further, although specific numerical values are described in the detailed description of the present invention, various other modifications can be readily applicable to the carrier sense apparatus according to the present invention.

As apparent from the above description, in the case where the carrier sense apparatus according to the present invention is adapted to data communication systems, it reduces the load on hardware and the probability of false alarms in case of detecting a start or end time point of a reception signal. Also, the carrier sense apparatus reduces a time error value between a reception data frame and a real data frame.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A carrier sense apparatus for data communication, comprising:
a power converter for converting a voltage value of an input signal into a power value;
a power accumulator for accumulating the power value for a prescribed window interval;
a power threshold comparator for comparing an accumulated power value generated from the power accumulator with a predetermined power threshold value, and generating the result value; and
a time threshold comparator for counting a predetermined time for which the result value generated from the power threshold comparator is continuously maintained, and determining whether the counted time exceeds a predetermined time threshold value.

2. The carrier sense apparatus according to claim 1, wherein the power accumulator includes:
a first delay having at least one delay component for storing power values of sample signals generated from the power converter, and delaying signal transmission;
a subtracter for subtracting an output power value of the first delay from the power values of the sample signals generated from the power accumulator;
a second delay for delaying an output power value of the subtracter by one sample; and
an adder for adding an output power value of the second delay and the output power value of the subtracter.

3. The carrier sense apparatus according to claim 2, wherein the first delay stores power values of sample signals during a window interval, and then sequentially outputs the stored power values one-sample by one-sample using a FIFO (First Input First Output) method.

4. The carrier sense apparatus according to claim 1, wherein the power threshold comparator compares respective accumulated power values at start and end time points of the input signal with respective different power threshold values.

5. The carrier sense apparatus according to claim 1, wherein the power threshold comparator includes:
a multiplexer for selecting one of the power threshold values at the start and end time points of the input signal on the basis of an output signal of the time threshold comparator;
an adder for adding a power value of an input signal of the power threshold comparator and an output threshold value of the multiplexer; and
an overflow selector for generating an overflowed MSB (Most Significant Bit) from an output value of the adder.

6. The carrier sense apparatus according to claim 1, wherein the time threshold comparator compares respective values at start and end time points of the input signal with respective different power threshold values.

7. The carrier sense apparatus according to claim 1, wherein the time threshold comparator includes:
a first XOR gate for receiving an output value of the power threshold comparator and an output value of the time threshold comparator as input signals;
a counter for counting a duration time of the output value when an output value of the XOR gate is reset, and generating a predetermined count value;
a multiplexer for selecting one of time threshold values at start and end time points of the input signal on the basis of an output result of the time threshold comparator;
an adder for adding a result value of the counter and a threshold value generated from the multiplexer;
an overflow selector for generating an overflowed MSB (Most Significant Bit) from an output value of the adder; and
a second XOR gate for receiving a result value of the overflow selector and an output value of the time threshold comparator as input signals.

8. The carrier sense apparatus according to claim 1, wherein the time threshold comparator has the functions of:
a) in case of detecting a start time point of the input signal, if the power threshold comparator determines that the accumulated power value is higher than the power threshold value and a counted time for which a result value of the power threshold comparator is maintained exceeds a time threshold value for detecting the start time point of the input signal, activating a carrier sense signal; and
b) if the result value of the power threshold comparator is changed to other values, initiating the counting operation.

9. The carrier sense apparatus according to claim 1, wherein the time threshold comparator has the functions of:
a) in case of detecting an end time point of the input signal, if the power threshold comparator determines that the accumulated power value is less than the power threshold value and a counted time for which a result value of the power threshold comparator is maintained exceeds a time threshold value for detecting the end time point of the input signal, inactivating a carrier sense signal; and
b) if the result value of the power threshold comparator is changed to other values, initiating the counting operation.
